(19) United States
(12) Patent Application Publication
(10) Pub. No.: US 2005/0108305 A1
(43) Pub. Date: May 19, 2005

(54) Management of storage space for an embedded database in a software system

(75) Inventors: Yuandan Lou, Cupertino, CA (US); George B. Meng, San Francisco, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 10/715,323

(22) Filed: Nov. 17, 2003

(51) Int. Cl. G06F 17/30; G06F 7/00

(52) U.S. Cl. 707/205; 707/204; 707/206; 707/9

(57) ABSTRACT

The present teachings relate to management of storage space for embedded databases in software systems. In various embodiments, the present teachings enable a user to (i) pre-allocate disk space for an embedded database; and/or, (ii) change the disk space allocated to an application's embedded database. The former can be effected, in various embodiments, when the software application is installed, and the latter when the software is running. One or both of these tasks can be accomplished via a graphical user interface (GUI) permitting and facilitating user interaction.

### FIELD

The present teachings relate to management of storage space for embedded databases in software systems.

### INTRODUCTION

As the price of relational databases decreases and the performance increases, particularly in a personal computing environment, it is becoming increasingly popular to embed a relational database within software applications. In this setting, the relational database essentially becomes part of the application, and the software end-users are not aware of the presence of the relational database. In fact, it is often the goal and hope of application vendors that users do not know or do not need to know anything about the database. Customers purchasing this type of software application often lack the database resources or technical expertise to manage a database. But due to the intricacies of the relational database, the embedded database has to be managed somehow, especially related to its space. Because the; application vendors do not know all of the computer configurations their applications are going to be installed upon, the common approach is that applications allocate a small amount of space when installed and make it auto extensible so that when a need arises to store more data, the database grows by itself (i.e., without user awareness and/or intervention) within a pre-set limit. The initial size of the database, and how big the database can grow, are all unknown to a user. There are a number of potential problems with this common approach; e.g.: (1) A user generally does not know what's going on with database space. When the database stops growing due to either reaching the preset limit or hard disk space max out, it's often too late, which can result in loss of data; and (2) Even if a user knows that the database is almost full from his/her experience with the application, there is generally no convenient way for him/her to allocate more space to the embedded database.

### BRIEF DESCRIPTION OF FIGURES

FIG. 1 illustrates a graphical user interface (GUI) displaying available disk space to a user, and enabling the user to allocate a selected amount of the available disk space for use by an embedded database, in accordance with various embodiments. In the example shown, in the course of installing an application (here, GeneMapper™ software from Applied Biosystems; Foster City, Calif.) with an embedded database, a user has allocated 3 GB in drive “E:” and 50 GB in drive “F:”

FIG. 2 illustrates a GUI associated with a database manager that monitors disk space usage while an application is running, in accordance with various embodiments. The database manager can tell a user how much disk space is used and/or how much remains available. In the example shown, the database manager provides a disk allocation capability whereby a user can add more disk space to the application's embedded database.

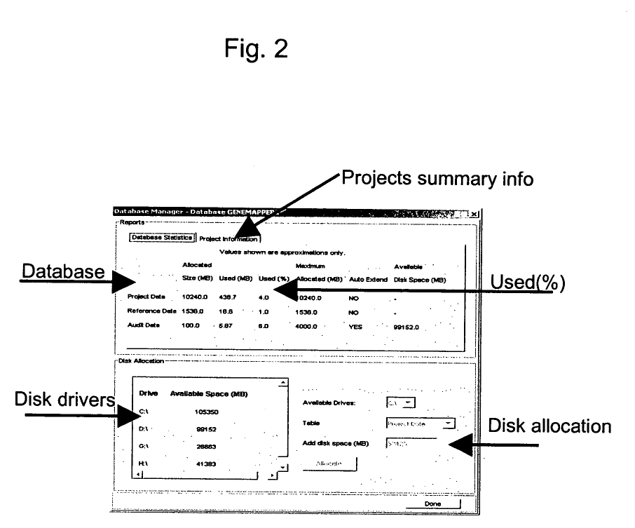

FIG. 3 is a block diagram that illustrates an example of a computer system, according to certain embodiments, upon which various embodiments of the present teachings can be implemented.

### DESCRIPTION OF VARIOUS EMBODIMENTS

Reference will now be made to various embodiments, examples of which are illustrated in the accompanying drawings. While the present teachings will be described in conjunction with various embodiments, it is not intended that the present teachings be limited to such embodiments. On the contrary, the present teachings are intended to cover various alternatives, modifications, and equivalents, as will be appreciated by those of skill in the art.

The present teachings relate to management of storage (e.g., disk) space for embedded databases in software systems.

The present teachings can be implemented in a computer system, such as a personal computer (PC), Macintosh, or similar system. In various embodiments, the present teachings are embodied, at least in part, in a graphical computing environment.

In various embodiments, the present teachings provide a software application comprising an embedded database and one or more storage-space-management tools. The database can comprise, for example, embedded SQL (SQL statements placed within an application program, sometimes referred to as a host program).

In various embodiments, the present teachings enable a user to (i) pre-allocate disk space for an embedded database; and/or, (ii) add more disk space to an application's embedded database. The former can be effected, in various embodiments, when the software application is installed, and the latter when the software is running (operating). One or both of these tasks can be accomplished via a graphical user interface (GUI) permitting and facilitating user interaction.

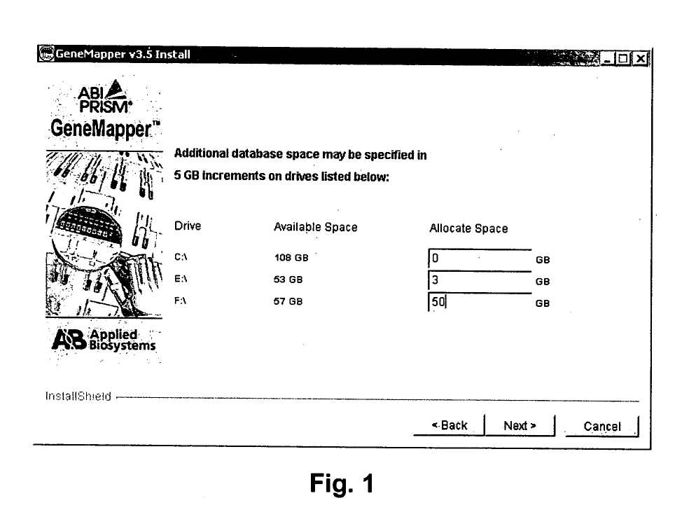

In various embodiments, for example, when the software application is installed, a pre-allocation scheme can be used to allow a user to pre-allocate disk space for the embedded database. The pre-allocation scheme can work, for example, in the following way: A search on the user's local machine can be performed and the available disk space presented to the user. The user can allocate a selected amount of the available disk space to the application. In some embodiments, for example, a pre-set default value can be filled-in (replaced) by the user. A non-limiting embodiment of a GUI permitting and facilitating such actions is shown in FIG. 1. After the user fills-in the allocation, the installer creates the overall size of the embedded database. The database file(s) created in this scheme can be fixed in size. In this manner, the user knows exactly how big the database is when installed. Since a user often knows how much data he/she is going to produce (low/medium/high throughput), the approach provides an excellent solution.

In various embodiments, when the software is running (operating), a database manager can be used to monitor the disk space usage. The database manager can tell a user how much disk space is used and/or how much remains available. In some embodiments, this information can be categorized, for example, according to distinct types of application data so that a user can have fine control over which data needs more space. The database manager can provide an early warning mechanism to a user about the database space. In some embodiments, the database manager can also provide a disk allocation capability. A user can add more disk space to the application's embedded database, if he/she desires, to selected application data. This provides a dynamic solution for overrunning the application's storage problem.

Those skilled in the art will appreciate that any of a variety of user editable fields can be employed. For example, and without limitation, text fields, drop down lists, scroll bars or boxes, among others.

In some embodiments, when the space usage reaches a predetermined threshold, the system can auto adjust the maximal amount of space according to a predefined set of rules without user intervention. The adjustment can be done, for example, per data type stored in the database. Such adjustment can be recorded in the system so that it can be traced if needed.

The rules can be set, for example, by the developer (prior to sale or distribution; i.e., prior to reaching an end user), and optionally can be adjustable by the user for one or more parameters included in the rules. For example, for a rule like “Increment space by 5 GB when the usage is reaching 80%”, the “5 GB” and “80%” values can be set upon release of the software, and optionally can be adjusted (reset) by a user in certain user interface implementations.

Among other things, the pre-allocation scheme in the software installation process can allow a user to know exactly how large the data storage is. The disk allocation design in the database manager can, for example, allow a user to know the space usage and to allocate more space, if needed or desired.

The present teachings can be employed, for example, in life-sciences software applications (e.g., genomics; proteomics; etc.). For example, the present teachings can be embodied in a software system for (i) DNA and/or protein sequence analysis, (ii) polymorphism detection, (iii) allelic discrimination, (iv) gene expression analysis, (v) bio-analyte detection, (vi) comparative sequence analysis, and/or (vii) gene expression profiling, and the like. The present teachings can be incorporated in software applications such as, without limitation, GeneMapper software; BioTrekker software; SDS software; and/or SeqScape software (Applied Biosystems; Foster City, Calif.). Various embodiments, for example, contemplate databases storing, among other things, polynucleotide and/or protein data (e.g., sequence data; polymorphism data; mutation data; etc.). The present teachings (e.g., an embedded database and a space-management GUI at installation and/or while running) can be incorporated in software technology such as, without limitation, that disclosed in U.S. patent application Ser. No. 09/724,910 (filed Nov. 28, 2000), Ser. No. 09/911,903 (filed Jul. 23, 2001), Ser. No. 10/279,746 (filed Oct. 23, 2002), Ser. No. 10/293,960 (filed Nov. 13, 2002), Ser. No. 10/241,751 (filed Sep. 9, 2002); U.S. Provisional Patent Application No. 60/479,332 (filed Jun. 18, 2003); and U.S. Pat. Nos. 5,538,897, 6,229,911, 6,532,462, 6,567,540, 6,185,561, 6,484,183; all of which are incorporated herein by reference.

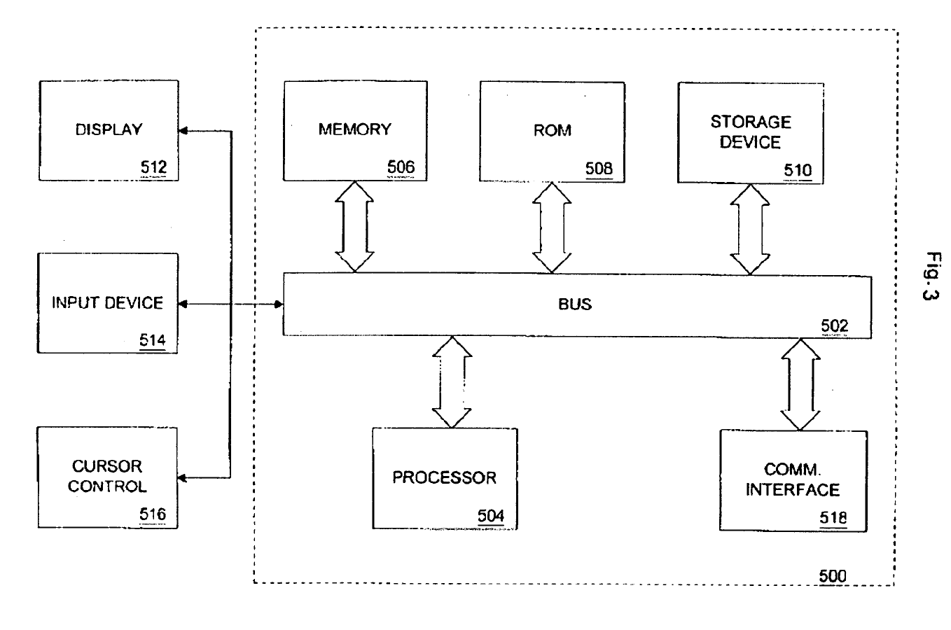

As indicated above, the present teachings can be implemented in a computer system, such as a personal computer (PC), Macintosh, or similar system. FIG. 3 is a block diagram that illustrates a computer system 500, according to various embodiments, upon which various embodiments of the present teachings may be implemented. Computer system 500 includes a bus 502 or other communication mechanism for communicating information, and a processor 504 coupled with bus 502 for processing information. Computer system 500 also includes a memory 506, which can be a random access memory (RAM) or other dynamic storage device, coupled to bus 502, and instructions to be executed by processor 504. Computer system 500 further includes a read only memory (ROM) 508 or other static storage device coupled to bus 502 for storing static information and instructions for processor 504. A storage device 510 (such as, without limitation, a magnetic disk, optical disk, magnetic tape, or the like) is provided and coupled to bus 502 for storing information and instructions.

Computer system 500 can be coupled via bus 502 to a display 512, such as a cathode ray tube (CRT) or liquid crystal display (LCD), for displaying information to a computer user. An input device 514, including alphanumeric and other keys, is coupled to bus 502 for communicating information and command selections to processor 504. Another type of user input device is cursor control 516, such as a mouse, a trackball or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

In operation, processor 504 can execute one or more sequences of one or more instructions contained in memory 506. Such instructions can be read into memory 506 from another computer-readable medium, such as storage device 510. Execution of the sequences of instructions contained in memory 506 causes processor 504 to perform the process states described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as memory 506. Transmission media includes coaxial cables, copper wire, and fiber optics, including the wires that comprise bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD, DVD, and any other optical medium, punch cards, papertape, any other physical medium with patterns of holes, a RAM, PROM, and EPROM, a FLASH-EPROM, any other memory chip or cartridge, a carrier wave, or any other medium from which a computer can read.

Those having ordinary skill in the art will understand that many modifications, alternatives, and equivalents are possible. All such modifications, alternatives, and equivalents are intended to be encompassed herein.

1. A computer program product for use on a computer system including one or more storage devices and a display device, said product comprising: (i) a software application, (ii) a database embedded in said software application, and (ii) a computer-executable set of instructions for generating a graphical user interface on said display device, the graphical user interface including (a) a first display portion showing said one or more storage devices, (b) a second display portion showing free space available for use by said database on said one or more storage devices, and (c) a third display portion comprising an editable field for receiving a user-defined space allocation value, whereby a user can set a maximal amount of space usable by said database.

2. The product of claim 1, wherein at least one of said storage devices comprises an optical or magnetic disk drive.

3. The product of claim 1, wherein said embedded database comprises a relational database configured to store (i) DNA sequence data, (ii) protein sequence data, or (iii) both DNA sequence data and protein sequence data.

4. The product of claim 1, further comprising a second set of computer-executable instructions defining an installation routine whereby said program product is installed upon said computer system, and wherein said graphical user interface is generated in the course of said installation routine.

5. The product of claim 1, further comprising a second set of computer-executable instructions for monitoring, while said program is running, space usage of said one or more storage devices, and generating a second graphical user interface, said second graphical user interface including a first display portion showing space usage on said one or more storage devices, and a second display portion comprising an editable field for receiving a user-defined space allocation value, whereby a user can change the maximal amount of space usable by said database.

6. The product of claim 5, wherein said second graphical user interface is generated while said program is running, upon said space usage reaching a predetermined threshold.

7. The product of claim 5, wherein said database stores a plurality of data types, and wherein said first display portion of said second graphical user interface shows space usage for each of said data types, individually; and wherein said second display portion of said second graphical user interface is configured to receive a user-defined space allocation value for each of said data types, individually.

8. The product of claim 1, further comprising a second set of computer-executable instructions for monitoring, while said program is running, space usage of said one or more storage devices, and generating a space-usage warning on said display device, when the space usage reaches a predetermined threshold.

9. The product of claim 1, further comprising a second set of computer-executable instructions for monitoring, while said program is running, space usage of said one or more storage devices, and automatically adjusting, by a preset quantity, the maximal amount of space usable by said database, when the space usage reaches a predetermined threshold.

10. The product of claim 9, wherein said database stores a plurality of data types, and further wherein the adjusting is done per data type stored in the database.

11. The product of claim 10, wherein the adjustment is recorded in a memory or storage such that it is traceable.

12. The product of claim 9, further comprising a third set of computer-executable instructions for generating a second graphical user interface including an editable field permitting a user to override said preset quantity.

13. An interface executed by programmed instructions on a general purpose computer; the general purpose computer including a memory for holding the programmed instructions, an input device for supplying input information for interaction with the programmed instructions, and a display device for displaying information created by the programmed instructions and the input information; said interface operating in conjunction with an underlying database embedded in an associated computer software product, wherein said interface comprises: a first display portion showing one or more storage devices accessible by said computer, a second display portion showing free space available for use by said database on said one or more storage devices, and a third display portion comprising an editable field for receiving a user-defined space allocation value, whereby a user can set a maximal amount of space usable by said database.

14. A storage space management system, comprising: (a) a display; (b) a processor operatively connected to said display; (c) an input device operatively connected to the processor; and (d) a memory having computer software operative by the processor, said software including: a database embedded therein, computer-executable instructions for generating a graphical user interface on said display, the graphical user interface including a first display portion showing one or more available storage devices, a second display portion showing free space available for use by said database on said one or more storage devices, and a third display portion comprising an editable field for receiving a user-defined space allocation value, whereby a user can set a maximal amount of space usable by said database.

15. A storage space management system, comprising: (1) a display, (2) a processor operatively coupled to said display; (3) an input device operatively connected to the processor; (4) a memory operatively coupled to said processor, (5) one or more storage devices adapted for communication with said memory, and (6) software, in one or both of said memory and said storage devices, said software comprising a host application and a database embedded in said host application, said software further comprising computer-executable instructions for (i) generating and displaying upon said display a graphical user interface, the graphical user interface including a first display portion showing one or more available storage devices, and a second display portion showing free space available for use by said database on said one or more storage devices, (ii) eliciting and receiving from a user a space allocation value, and (ii) setting a maximal amount of space usable by said database equal to said space allocation value.

16. The system of claim 15, wherein said host application is a life-sciences software application.

17. The system of claim 15, wherein said embedded database comprises a relational database configured to store (i) DNA sequence data, (ii) protein sequence data, or (iii) both DNA sequence data and protein sequence data.

18. A method for management of space on one or more storage devices of a computer system, said method comprising:
during an installation routine, whereby a user installs on said computer system a software application having a relational database embedded therein:
(i) determining an amount of unused space available to said database on said storage devices,
(ii) presenting said amount to a user via a graphical user interface on a display of said computer system;
(iii) receiving from said user a user-defined allocation of space to make available to said embedded database; and
(iv) creating one or more database files on said storage space, having a maximal size based on said user-defined allocation.

19. A method for management of space on one or more storage devices of a computer system, said method comprising:
while a software application is running on said computer system, said software application including an embedded database having an upper size limit:
(i) determining an amount of unused space available to said database on said storage devices,
(ii) presenting said amount to a user via a graphical user interface on a display of said computer system; and
(iii) increasing said upper size limit.

20. The method of claim 19, wherein said increasing is carried out upon said amount reaching a predetermined threshold.

21. The method of claim 19, wherein step (ii) further comprises presenting a user-editable field to said user and receiving from said user a user-defined space allocation value, which value is then used to establish said upper size limit.
